(19) United States
(12) Patent Application Publication
(10) Pub. No.: US 2021/0206014 A1
(43) Pub. Date: Jul. 8, 2021

(54) PORTABLE PIPE CUTTER SYSTEM

(71) Applicant: Jordan Turney, Leduc (CA)

(72) Inventor: Jordan Turney, Leduc (CA)

(21) Appl. No.: 16/736,769

(22) Filed: Jan. 7, 2020

(51) Int. Cl. B26D 7/01; B26D 3/16; B26D 5/10

(52) U.S. Cl. CPC B26D 7/01; B26D 1/02; B26D 5/10; B26D 3/16

(57) ABSTRACT

A height adjustable portable levelling pipe cutter system is disclosed that keeps all sizes of pipe, secure and at proper cutting height, so clean precise cuts can be made. The system works with a variety of cutters and devices and keep level straight pipe for even cuts. The portable system holds and cuts all pipe sizes and can be adapted for many types of cutting systems, and can also hold laser measuring tools to ensure proper cut length. The system relates to a construction tool for proper cutting of all sizes of pipe in a safe ergonomic adjustable portable system.

### FIELD OF THE INVENTION

The present disclosure relates to a height adjustable levelling pipe cutter system and is particularly concerned with a system that holds and cuts all pipe sizes in a safe, ergonomic, compact, portable system.

### BACKGROUND

Methods of cutting metal pipes on construction sites are lengthy, costly, and sometimes challenging in terms of meeting codes and standards in terms of quality and safety. The more productive and modern methods of cutting pipes are therefore confined to local fabrication shops due to their physical size and immobility and are not used onsite.

The cuts that are performed onsite are done using conventional and often cumbersome systems mounted on the pipe, or other mechanical methods such as grinding discs, toothed saws, and routers. These cuts require one or more skilled tradesmen, usually pipefitters and pipe welders, to understand piping systems, compute and calculate the cut profile, as well as measure and mark the cut. Performing the cut itself requires good operator skill and predetermined engineering quality standards need to be met. The degree of difficulty in performing the cut depends on the complexity of the joint and can range from a straight cut to a mitered and coped cut with weld preparation bevel. Some cuts are extremely challenging for a tradesman to compute and mark due to their eccentricity and complexity and are performed by trial and error by repeated test fitting.

Further, a single pipe can have multiple cuts and holes further increasing the risk for incorrect cuts requiring repair and rework. Larger and longer pipes are very heavy and difficult to cut and the safety hazard is increased when handling. Further, cutting a single joint onsite using conventional methods can take a considerable time and will usually require more than one tradesman to perform cuts.

As will be readily appreciated, there is a need for improved efficiency, reduced cost, better quality, and safer methods for cutting pipe onsite. Despite this, there have been few attempts to improve pipe cutting onsite.

U.S. Pat. No. 5,894,771A—discloses a process and arrangement for cutting and/or chamfering pipes, in particular thick-walled pipes. The arrangement includes support rollers and a laser measuring device which is mounted on a machine bed that measures the external diameter of the pipe to the cutting region and then transmits the measured values to a CNC-control unit which then controllably adjusts the cutting machine accordingly. The support rollers can be vertically adjusted.

US20150174661A1—discloses a pipe cutting system having a support assembly including an inner frame which can be lifted vertically on an outer frame. The system can adjust to accommodate larger and smaller pipes. An alternative arrangement comprises a plurality of rollers and driven rollers.

JP2011073088A—discloses a pipe cutting tool. The tool comprises a pair of parallel support rollers arranged on a base and a roller interval adjusting means for adjusting an interval between both support rollers in response to an outer diameter of the pipe to be cut. The pipe cutting tool has fixed support rollers and freely movable support rollers relative to the fixed support rollers.

WO2011037425A2—discloses a pipe cutting machine that includes roller bearings arranged at regular intervals at the inner surface of a mount groove, thereby enabling in-place rotation of the pipe at the mount groove once the pipe to be cut is placed thereon. The pipe cutting machine has a pipe auxiliary base having an adjustable height disposed at the side of the pipe mount.

U.S. Pat. No. 6,981,437B2—discloses a pipe cutting machine comprises a clamping device for holding a pipe to be cut and a pipe cutting apparatus for cutting the pipe by revolving a rotating disc-like cutting blade around the circumferential surface of the pipe held by the clamping device. A plurality of rollers are arranged on the top of the pipe feed frame at regular intervals to extend in parallel relation with one another, transferring the pipe to a desired cutting position.

US20180214957A1—discloses an apparatus for cutting a pipe. The apparatus has a base comprising a pipe support having at least one set of lower rollers. The apparatus is adapted to machine or cut different sizes of pipe. A visual alignment aid, such as laser pointer or a mechanical pointer, may also be provided, to assist a user in aligning a pipe to be cut. The apparatus comprises a plurality of rollers for supporting and rotating a pipe to be cut. It has two pairs of first lower rollers, and two pairs of second lower rollers.

DE10039991A1—discloses a pipe cutting machine having two rotatable guide rollers and a rotatable cutting roller. The pipe to be cut is fixed between them. At least one of the guide rollers is motor-driven and rotates the pipe being cut. The spacing between the guide rollers and their spacing from the cutting rolling can be adjusted by a drive. The pipe cutter is characterized in that the distance of the knife roller relative to the guide rollers is adjustable by means of a spindle drive.

EP3115136A1—discloses a method for machining a tubular casing with a cutting tool and includes an optical measuring device. The tube is supported in a rotatable manner by a roller drive with wheels.

U.S. Pat. No. 4,222,795A—discloses an apparatus for cutting and beveling pipe comprising a horizontally positioned and movable member, roller means to support and axially rotate a horizontal pipe parallel to the member, a photocell scanner mounted on the member and positioned to follow a profile template circumscribing a pipe on the roller means, drive means, support on the member movable axially of a pipe on the roller means. The pipe is rotatably positioned on the turning rolls. Extending outwardly from one end of the apparatus is an arm that can be lengthened or shortened to properly position cutting torch at the correct angle when cutting.

US20140174266A1—describes an apparatus providing a carriage comprising a holding means for longitudinally holding the tubular body, the holding means comprising a rotatable element arranged to relatively rollingly engage with a surface portion of the tubular body. A peripheral friction drive roller is provided for rotating the tube about its own axis, whereas a pusher means is provided for longitudinally shifting the tube. an adjustment means is provided for adjusting the radial position of the rotatable element with respect to the tubular body,

None of the above cited documents, alone or in combination, satisfy the need for a portable, nestable, ergonomically adjustable pipe cutting system that can accommodate pipes of varying circumferences and includes a stably and safely mounted cutting tool which may incorporated a laser measuring device. Hence there is a need in the industry for an on-site pipe cutting system that offers an improvement in safety and accuracy, and to provide a safe working environment whilst reducing man hours for tasks thereby improving efficiency.

### BRIEF SUMMARY

In accordance with an aspect of the invention there is provided a portable pipe cutter system comprising: a frame defined by two or more longitudinal tracks and two or more lateral cross members, said frame being removably mounted on trolley frame supports; two or more pipe roller assemblies, configured to cooperate with each of the longitudinal tracks, each of the pipe roller assemblies having two or more pipe rollers; and a cutting device mounted on one of the lateral cross members, wherein, when a pipe is placed on the pipe rollers on the two or more pipe roller assemblies, the cutting device can be engaged to cut the pipe to a predetermined length.

In accordance with another aspect of the invention there is provided a process for cutting pipes, comprising the steps: assembling a frame comprising two or more longitudinal tracks and two or more lateral members, said frame being removably mounted on adjustable supports; attaching two or more pipe roller assemblies to cooperate with each of the longitudinal tracks, each of the pipe roller assemblies having two or more adjustable pipe rollers; mounting a cutting device on one of the lateral members; placing a pipe to be cut on the pipe roller assemblies; sliding the cutting device to an appropriately distance along the longitudinal tracks; engaging the cutting device to cut a section of the pipe; rotating the pipe on the pipe rollers and reengaging the device; and repeating the previous step until the pipe is completely cut around its circumference.

The advantages and features of the present invention will become better understood with reference to the following more detailed description and claims taken in conjunction with the accompanying drawings in which like elements are identified with like symbols and in which:

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an isometric view of a pipe cutter system in accordance with one embodiment of the invention.

FIG. 2 illustrates a cross section view of the first end of the pipe cutter system in accordance with a further embodiment of the invention.

FIG. 3 illustrates a cross section view of the first end of the pipe cutter system in accordance with another embodiment of the invention.

FIG. 4 illustrates a cross section view of the central section of the pipe cutter system in accordance with yet another embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The present invention describes a height adjustable and collapsible pipe cutter system. In operation, pipes of various lengths and diameters can be cut safely, accurately and at an ergonomically appropriate level. The cutting device, which may be a grinding disc, a toothed saw, or router, is held in place on the frame of the pipe cutter system, thereby achieving a smooth cut surface. When a laser measuring device is employed, the pipe cutter system can also achieve reproducible pipe cutting results. It is additionally contemplated that the cutting device may be linked to a CNC-control unit which controllably adjusts the cutting machine.

The process of the invention includes the steps of placing a pipe to be cut on the roller assemblies, and adjusting the roller assemblies along the trolley frame so that the pipe is securely supported at both ends and in the middle. Rollers on each of the roller assemblies can also be adjusted to accommodate pipes of varying diameters. The height of the cutter system can then be adjusted so that the frame is at an appropriate ergonomic height for the operator. The central roller assembly, typically containing the cutting device, can then be moved along the trolley track such that the cutting device is aligned at the position where the cut is to be made. A laser device, or some other form of measuring tool is used to assist in determining the positioning of the cutting device. When the cutting device is in the correct position, the cutting surface of the cutting device is engaged with the pipe. The pipe is manually rotated, and the cutting surface of the cutting device is re-engaged with the pipe. This process is repeated until the pipe is completely cut around the entire circumference.

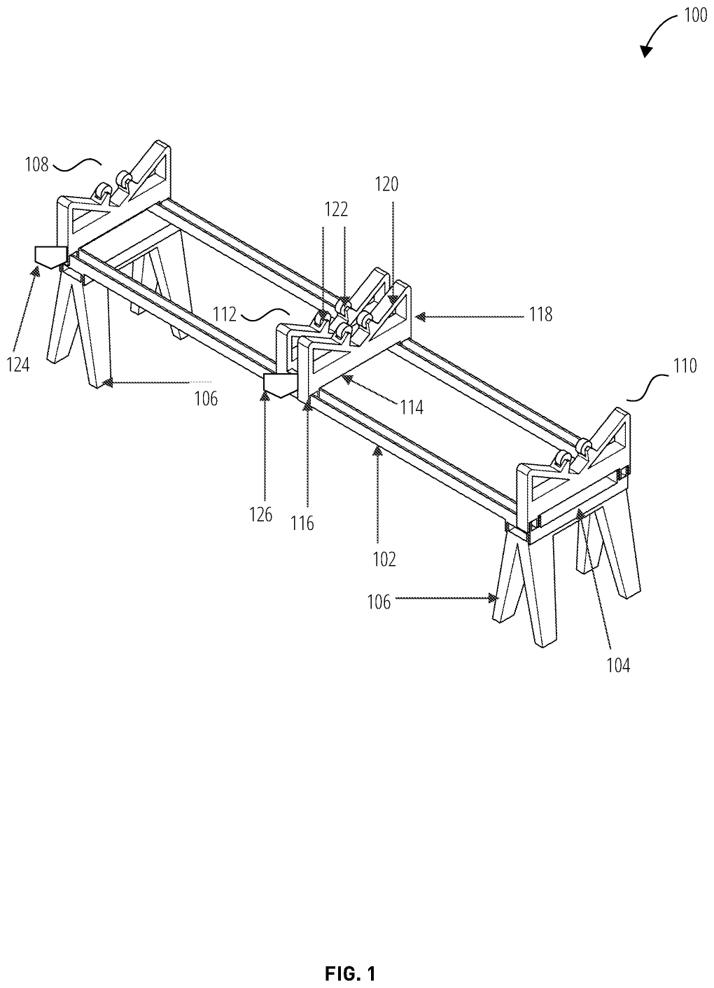

FIG. 1 illustrates a pipe cutter system in accordance with one embodiment of the invention. The pipe cutter system comprises a roller trolley frame 100 having a lower trolley track 102, a lateral cross member 104, and trolley frame support 106. The pipe cutter system further comprises a first end pipe roller assembly 108, a second end pipe roller assembly 110, and a central pipe roller assembly 112. Each of the roller assemblies (108, 110, and 112) comprise a horizontal roller support 114 that is connected to an upper trolley track 116 that is sized to cooperate with the lower trolley track 102. The horizontal roller support 114 is further connected at each end to a vertical roller support 118 and a roller adjustment member 120. The roller adjustment member 120 is adapted to receive one or more pipe rollers 122. The first end pipe roller assembly 108 and second end pipe roller assembly 110 typically comprise a single roller assembly, whereas the central pipe roller assembly 112 typically comprises two roller assemblies either in close alignment or preferably a unitary assembly comprising two closely aligned roller assemblies. In an alternate version the positioning of the central pipe roller assembly 112 to the required measurement adjustment can be motorized. A small motor attached to the roller assembly 112 uses a small drive wheel engaged with the inside of the lower trolley track 102 to convey the roller assembly along the track stopping at the required measurement. The measurement can be entered on a keypad or spoken with voice command. This function frees up the operator to speak the measurement while his hands are occupied getting the next piece of pipe.

The first end pipe roller assembly 108 may additionally comprise a first end laser device 124 that is aligned with the first end of a pipe. The central pipe roller assembly 112 may additionally comprise a central laser device 126 that indicates the desired cutting line of the pipe. The trolley frame support 106 is adjustable so that the height of the roller trolley frame 100 can be positioned at an ergonomically appropriate level.

The various trollies can be locked into position once set with a simple clamping action or cam lock. This can be achieved in a very simple and easy manner, such as turning a key.

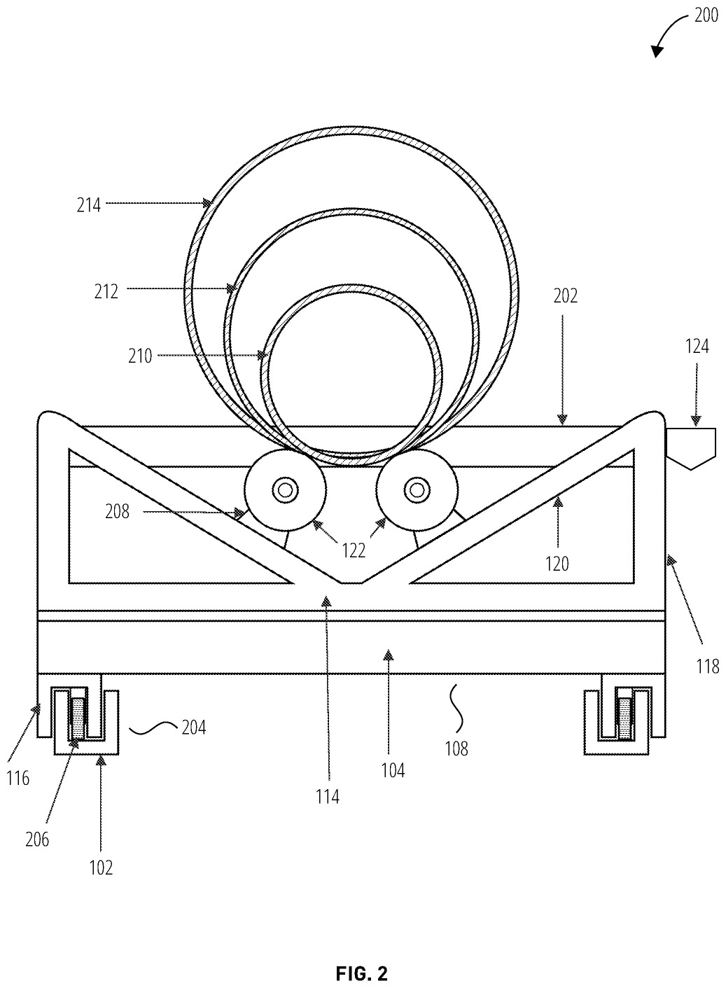

FIG. 2 illustrates a cross sectional view of the first end pipe roller assembly 108. In this embodiment of the invention, the first end pipe roller assembly 108 additionally comprises a pipe stop bar 202. The first end of the pipe to be cut is aligned with the pipe stop bar 202 and, when present, the first end laser device 124. FIG. 2 additionally shows in greater detail the structure of a typical trolley wheel assembly 204. The trolley frame support 106 and upper trolley track 116 may be sized to cooperate in an offset manner as shown. A wheel 206 is attached to the upper trolley track 116 to facilitate the movement of the first end pipe roller assembly 108 along the trolley frame support 106. In an alternative embodiment that is contemplated, the upper trolley track 116 containing, a wheel 206, is sized to fit within the trolley frame support 106. In a further embodiment, the upper trolley track 116 containing, a wheel 206, is sized to fit on the outside of the trolley frame support 106. FIG. 2 further shows the mounting of an adjustable roller support 208 on a roller adjustment member 120. The adjustable roller support 208 may be able to accommodate small pipe 210, medium pipe 212, or large pipe 214, or it can be moved if necessary.

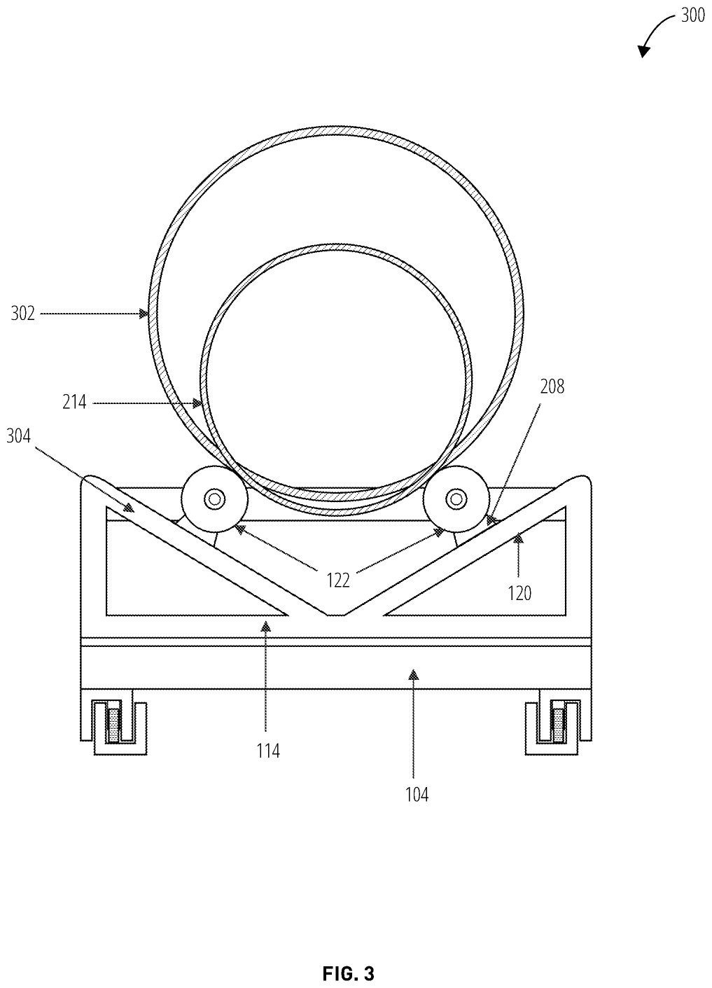

FIG. 3 illustrates how the adjustable roller support 208 can be moved to different positions on the roller adjustment member 120 to accommodate pipes of different sizes. Large pipe 214 and extra large pipe 302 can be more stably accommodated on the roller adjustment member 120 if the adjustable roller support 208 is moved to the outer edge of roller adjustment member 304.

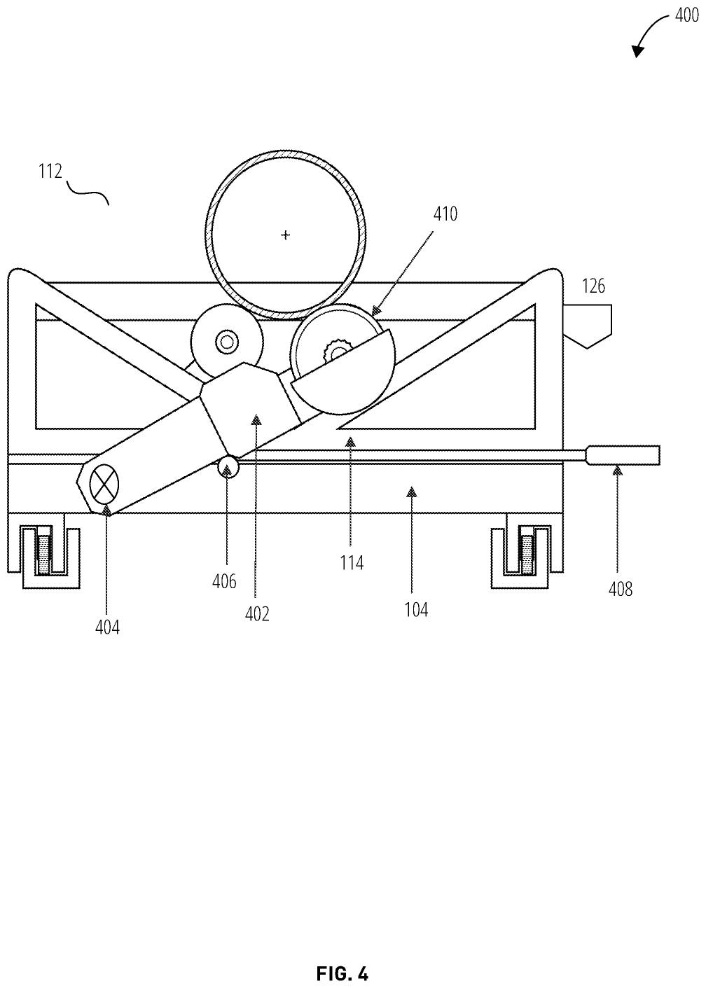

FIG. 4 illustrates a cross sectional how, in one embodiment of the invention, the grinder 402 is attached to the central pipe roller assembly 112. The grinder 402 is attached to the lateral cross member 104 by a grinder pivot point 404. The lateral cross member 104 further has a grinder resting support 406 to support the grinder 402 when it is not in use. A grinder lifting handle 408 is operatively associated with the grinder 402 such that the grinder cutting surface 410 can be elevated to project above the arc defined by the pipe rollers 122 and thereby interacting with the pipe to be cut. When the grinder lifting handle 408 is lifted such that the grinder cutting surface 410 cuts through the section of pipe to be cut, the pipe can then be manually rotated on the pipe rollers 122 such that the next section of pipe can be cut by the grinder cutting surface 410. The first end laser device 124 and central laser device 126, when present can assure the accuracy of the pipe cut. The grinder lifting handle 408 can be lifted manually. It can alternatively be associated with a screw thread mechanism that can cause the elevation of the grinder 402. In an additional embodiment, the grinder 402 can be raised or lowered by a motorized device.

In an alternative embodiment, the cutter would be engaged and remain engaged while the pipe is slowly turned by hand and being cut at the same time. Rather than it being engaged, manually rotated and then reengaging and repeated. Hence cutting and turning at the same time with holding the cutter in the engaged position continuously. One hand on the cutting handle and one hand slowly turning the pipe.

For the alternate version described above, where the grinder 402 can be raised or lowered by a motor, the rotation of the pipe may also be driven by a motor to complete the autonomy of the device. In this version the operator would only set the measurement and place the pipe onto the cutter while the lifting of the grinder and the rotation of the pipe would both be automated.

Each roller assembly (108, 110, and 112) are typically a unitary structure that will roll along the lower trolley track 102, each assembly is easily removable from the lower trolley track 102 for transport and storage. Similarly, the trolley frame support 106 are easily removable from the lateral cross member 104. The lateral cross member 104 can be designed such that they can be stackable for ease of transport or storage.

The pipe cutter system may be designed such that, when dis-assembled, the roller assemblies (first end pipe roller assembly 108, second end pipe roller assembly 110 and central pipe roller assembly 112) can fit within the trolley frame support 106. When the pipe roller assemblies and trolley frame supports are dimensioned to be nestable, this enables the system to be easily stacked for storage and transport.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

What is claimed is:

1. A portable pipe cutter system comprising:
a frame defined by two or more longitudinal tracks and two or more lateral cross members, said frame being removably mounted on trolley frame supports;
two or more pipe roller assemblies, configured to cooperate with each of the longitudinal tracks, each of the pipe roller assemblies having two or more pipe rollers; and
a cutting device mounted on one of the lateral cross members,
wherein, when a pipe is placed on the pipe rollers on the two or more pipe roller assemblies, the cutting device can be engaged to cut the pipe to a predetermined length.

2. The portable pipe cutter system of claim 1, wherein the pipe rollers are attached to the pipe roller assemblies by adjustable roller supports, thereby allowing the pipe roller assemblies to be moved into positions on the pipe roller assemblies to accommodate pipes of varying circumference.

3. The portable pipe cutter system of claim 1, wherein one or more of the pipe roller assemblies are supported by the lateral cross member.

4. The portable pipe cutter system of claim 1, further comprising a laser measuring tool to determine length of the pipe to be cut.

5. The portable pipe cutter system of claim 1, wherein the cutting device is manipulated into a cutting position by a handle.

6. The portable pipe cutter system of claim 1, wherein the cutting device is a grinder, saw, or router.

7. The portable pipe cutter system of claim 1, wherein the frame further comprises a pipe stop bar.

8. The portable pipe cutter system of claim 7, further comprising a laser measuring tool that is aligned with the pipe stop bar and the cutting device.

9. The portable pipe cutter system of claim 1, wherein the system comprises a first end pipe roller assembly, a second end pipe roller assembly and a central pipe roller assembly.

10. The portable pipe cutter system of claim 9, wherein the central pipe roller assembly comprises two roller assemblies in close alignment.

11. The portable pipe cutter system of claim 10, wherein the two roller assemblies are a unitary structure.

12. The portable pipe cutter system of claim 11, wherein the cutting device is positioned between the two roller assemblies.

13. The portable of pipe cutter system of claim 1, wherein the pipe roller assemblies and trolley frame supports are dimensioned to be nestable.

14. Use of the portable pipe cutter system of claim 1, to cut pipes comprising the steps of:
placing the pipe to be cut on the pipe rollers;
engaging the cutting device to cut a section of the pipe;
manually rotating the pipe on the pipe rollers until the pipe is completely cut around its circumference.

15. A process for cutting pipes, comprising the steps:
assembling a frame comprising two or more longitudinal tracks and two or more lateral cross members, said frame being removably mounted on adjustable supports;
attaching two or more pipe roller assemblies to cooperate with each of the longitudinal tracks, each of the pipe roller assemblies having two or more adjustable pipe rollers;
mounting a cutting device on one of the lateral cross members;
placing a pipe to be cut on the pipe roller assemblies;
sliding the cutting device to an appropriately distance along the longitudinal tracks;
engaging the cutting device to cut a section of the pipe;
rotating the pipe on the pipe rollers until the pipe is completely cut around its circumference.

16. The process according the claim 15, further comprising the step of;
adjusting position of the pipe rollers to accommodate circumference of the pipe.

17. The process according the claim 15, further comprising the step of;
adjusting height of the frame to an ergonomically appropriate height for operator.

18. The process according the claim 15, further comprising the step of;
determining the appropriately distance along the longitudinal tracks using a laser measuring device.
